(19) United States
(12) Patent Application Publication
(10) Pub. No.: US 2008/0264218 A1
(43) Pub. Date: Oct. 30, 2008

(54) Screw Strip

(76) Inventors: Kuo-Chou Wang, Lujhu Township (TW); Kuan-Hsiang Wang, Lujhu Township (TW)

Correspondence Address: Dr. BANGER SHIA;Int''l Patent Office of Bang Shia, 102 Lindencrest Ct, Sugar Land, TX, 77479-5201, US

(21) Appl. No.: 11/740,553

(22) Filed: Apr. 26, 2007

(51) Int. Cl. B25B 23/04

(52) U.S. Cl. 81/434

(57) ABSTRACT

The present invention discloses a screw strip having a rectangular strip, a plurality of receiving sleeves extending from the strip, and a plurality of advancing notches disposed on both sides of the rectangular strip. Each of advancing notches forms a closed state by a blocking of a side piece, thereby reducing the manufacturing cost. The screw strip is fixed firmly by the blocking of the side piece and can avoid sliding out of place or being deformed when screws are being pushed out.

### BACKGROUND OF THE INVENTION

1. Field of the Invention

The present invention relates to a screw strip, in particular a screw strip that can be fixed in place by the blocking of the side piece and avoid sliding out or being deformed.

2. Description of the Related Art

Referring to FIGS. 1 and 2, a conventional screw strip 1 comprises a rectangular strip 11, a plurality of receiving sleeves 12 extending from the rectangular strip 11, and a plurality of advancing notches 13 disposed on both sides of the rectangular strip 11; wherein each of said receiving sleeves 12 contains an open hole 121 within, while said open hole 121 receives a screw 3. At the end of each receiving sleeves 12 is formed a tapered portion 122, opposite to the rectangular strip 11; a plurality of break points 123 are disposed on the wall of the receiving sleeve 12 to form a plurality of shield walls 124 to hold the screw 3 in place.

When in use, the screw strip 1 is first installed within a screw gun 2. The screw strip 1 makes the initial move by rotating of the ratchet 21 of the screw gun 2 and moves along with the pushing force from the driving bit 22 to drive the screw 3 into the to-be-screwed object 4.

Disadvantages associated with the above-referenced conventional screw strip 1 are summarized below.
1. Since the advancing notches 13 of the conventional screw strip 1 are disposed on both sides of the rectangular strip 11, said notches 13 communicate with the outside. As a result, when being pushed by the screw gun 2, the screw strip 1 is not tightly engaged to the ratchet 21 as it is supposed to and is easily deformed, making the open hole 121 out of shape, which in turn obstructs the pathway of the screw 3 during its process of being pushed out of the screw strip 1, making the screw 3 jammed inside the screw gun 2. Furthermore, the obstruction of the pathway of the screw 3 demands more power of the screw gun 2, which can bear a substantial weight, therefore reducing working convenience.
2. Based on the above discussion, when the screw gun 2 is unable to hold the rectangular strip 11 of the screw strip 1 firmly in place, said rectangular strip 11 and the shield wall 124 can be deformed, making the screw 3 to be erroneously inclined and affecting the screwing accuracy.
3. The conventional screw strip 1 requires more manufacturing materials and cost while reducing working handiness due to the fact that the screw strip 1 needs to accommodate the advancing notches 13, which are physically disposed on both sides thereof.
4. When the screw 3 penetrates into the screw strip 1, the head 31 of the screw 3 is exposed outside of the rectangular strip 11 (since there is no place for the head 31), putting a restriction on the kinds or shapes of the screws that can be used for the conventional screw strip 1. For instance, screws with hex washer heads (not shown in the figures) can not be used in the conventional screw strip 1.

### SUMMARY OF THE INVENTION

The object of the present invention is to provide a cost-effective screw strip that helps the screws to be easily pushed out therefrom and accurately drives the screws into the object.

The screw strip in accordance with the present invention comprises a rectangular strip, a plurality of receiving sleeves extending from the rectangular strip, and a plurality of advancing notches disposed on both sides of the rectangular strip; wherein each of receiving sleeves has an open hole to accommodate a plurality of screws; moreover, a side piece is disposed by the side of each advancing notches, and said notch therefore forms a closed state.

To sum up, the present invention comes with the following advantageous functions:
1. Higher work efficiency and accuracy: Advancing notches of the screw strip in this invention form a closed state by the blocking of the side piece, the screw strip can be firmly fixed by the ratchet of the screw gun and be prevented from bending or deforming, which smoothes out the pushing process of the screw from the strip.
2. Greater handiness achieved with a lower manufacturing cost: Since advancing notches are physically disposed between two open holes, the width and the materials of the screw strip are reduced.
3. Broader applications for a diversity of screws: Since break points extend to the surrounding wall of the recess, any of the screws can be used to penetrate into the open hole and be easily pushed out after screwing.

While we have shown and described the embodiment in accordance with the present invention, it should be clear to those skilled in the art that further embodiments may be made without departing from the scope of the present invention.

### BRIEF DESCRIPTION OF THE DRAWINGS

The advantages of the present invention over the known prior art will become more apparent to those of ordinary skilled in the art upon reading the following descriptions in conjunction with the accompanying drawings.

FIG. 1 is a schematic view showing a conventional screw strip;

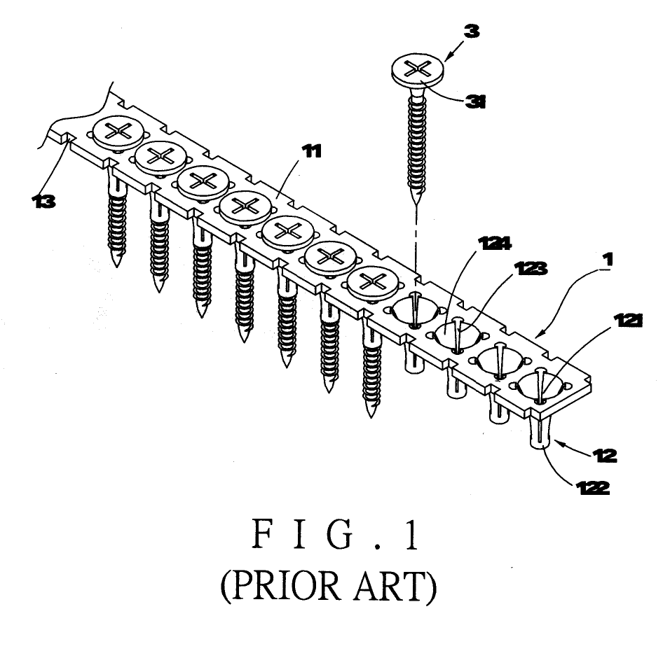

FIG. 2 is a schematic view showing the state of screwing of the conventional screw strip;

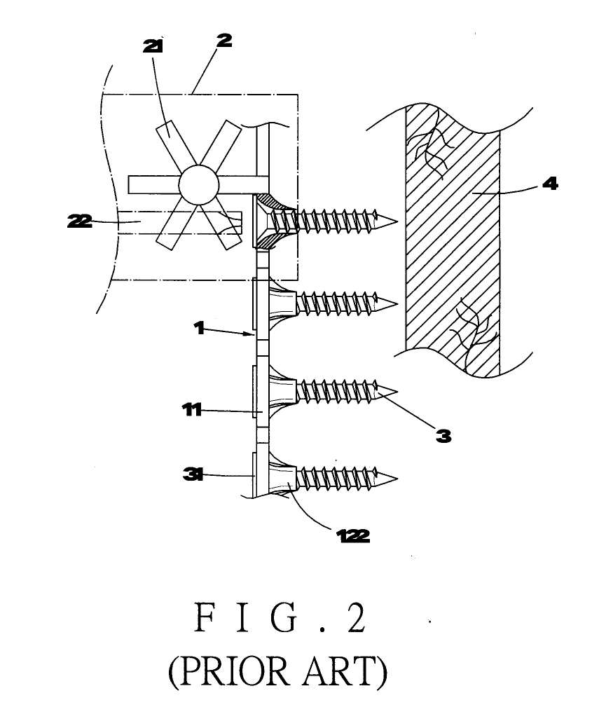

FIG. 3 is a schematic view showing the first preferred embodiment of the present invention;

FIG. 4 is a schematic view showing the state of screwing of the first preferred embodiment;

FIG. 5 is a schematic view showing the second preferred embodiment of the present invention; and

FIG. 6 is a schematic view showing the state of screwing of the second preferred embodiment.

### DETAILED DESCRIPTION OF THE PREFERRED EMBODIMENTS

Like elements of the present invention are denoted by the same reference numerals throughout the disclosure.

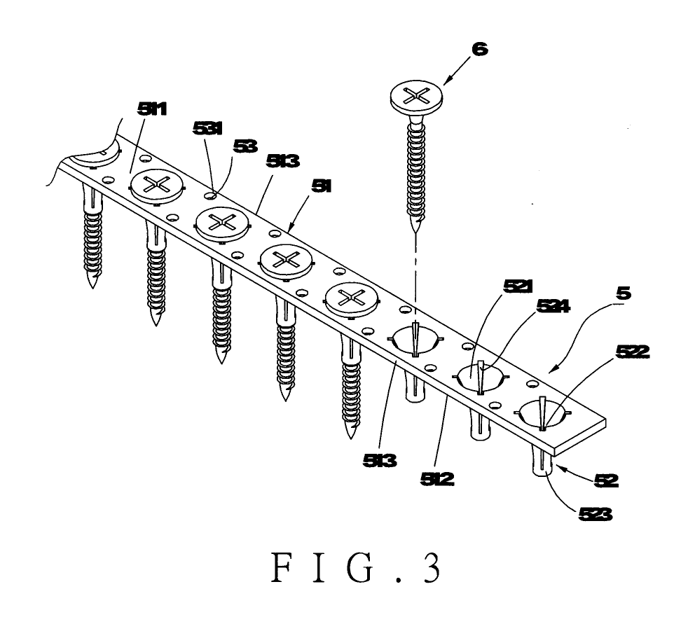

Referring to FIG. 3, the first preferred embodiment of the screw strip 5 comprises a strip 51, a plurality of receiving sleeves 52, and a plurality of advancing notches 53; wherein the strip 51 forms a rectangular and includes an upper surface 511, a bottom surface 512 opposite to said upper surface 511, and a flank 513 connects both the upper surface 511 and the bottom surface 512.

Each of said receiving sleeves 52 includes a shield wall 521 extending from the strip 51; wherein an open hole 522 is formed by the encirclement of the shield wall 521, and a tapered portion 523 opposite to the strip 51 is formed on the end of said shield wall 521. A plurality of break points 524 are disposed on said shield wall 521, divided into a plurality of petal-shaped pieces by said break points 524 for the screw 6 to be covered and fixed firmly by the shield wall 521 and the tapered portion 523 while driving the screw 6 into the receiving sleeve 52. A side piece 531 is disposed by the side of each advancing notches 53, which forms a closed state and can be a circle or a rectangle. The circle-shaped is adopted in this preferred embodiment. Compared with the related prior art, since advancing notches 53 are physically disposed between two open holes 522, the width of the screw strip 5 is highly reduced, increasing working efficiency while reducing manufacturing cost.

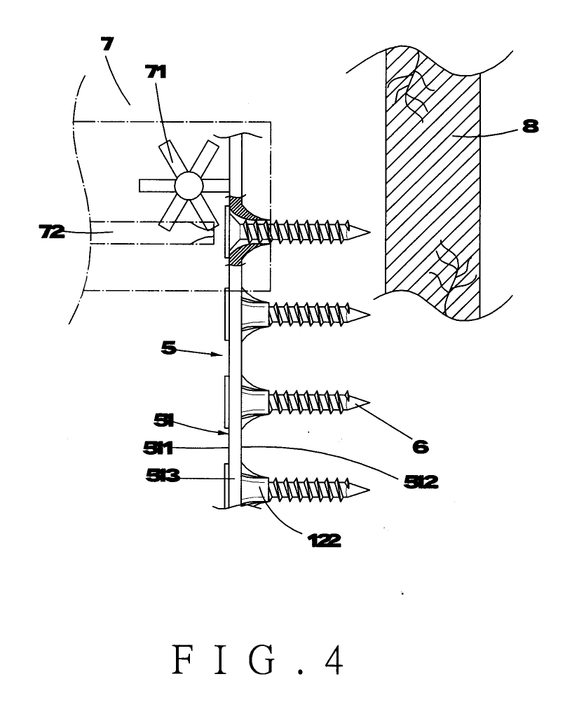

Referring to FIGS. 3 and 4, while in operation, the screw strip 5 is first installed inside a screw gun 7. The screw strip 5 makes its first move by the rotation of the ratchet 71 of the screw gun 7, accompanied by the pushing force from the driving bit 72. Comparing with the related prior art, advancing notches 53 of the screw strip 5 are blocked by the side pieces 531, which are disposed by the sides and do not communicate with the outside, the ratchet 71 can hold the strip 51 in place firmly, which preventing said strip 51 and said shield wall 521 from being deformed, making easier the process to push out the screw 6. As a result, the screw 6 is not screwed out of place or inclined to one side, increasing the screwing accuracy.

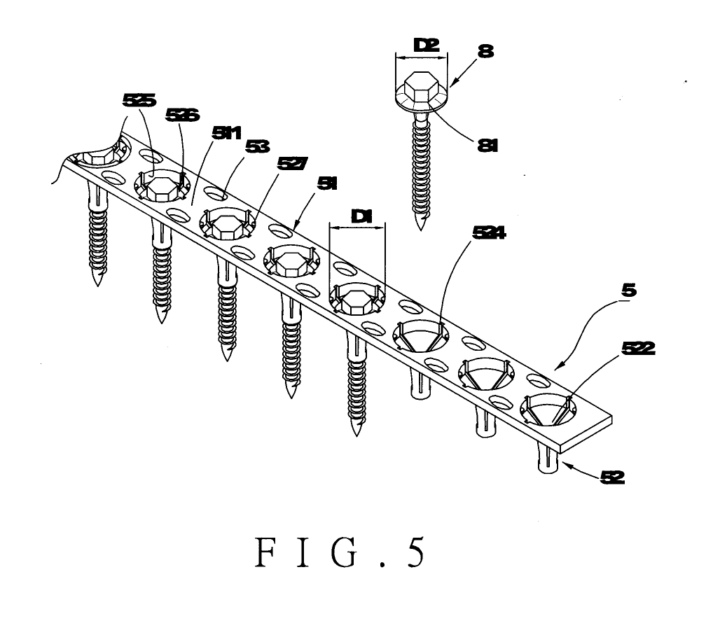

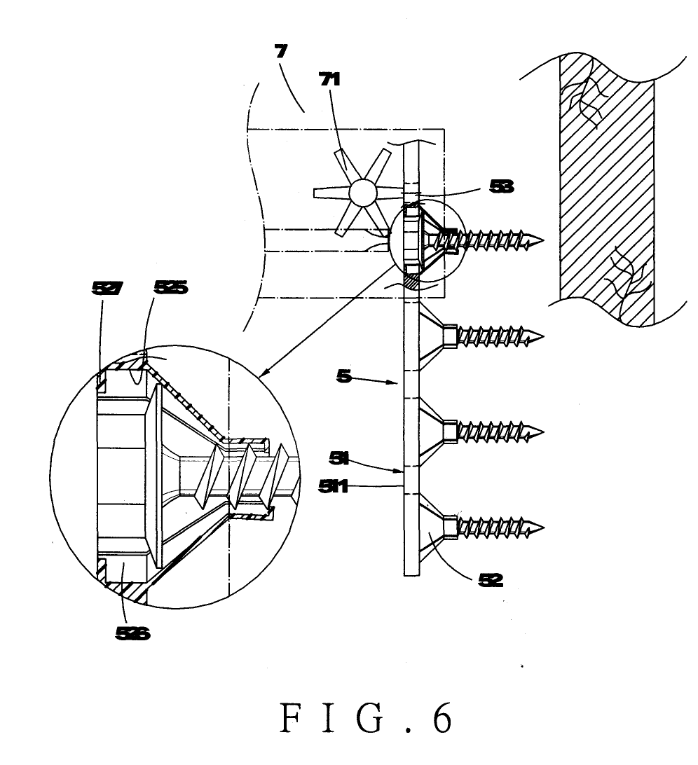

Referring to FIGS. 5 and 6, the second preferred embodiment of the screw strip 5 of the present invention comprises a strip 51, a plurality of receiving sleeves 52, and a plurality of advancing notches 53; the compositions of the elements and the functions are the same as the first preferred embodiment. To be more specific, the screw strip 5 is provided for the screw 8 with a hex washer head 81 to drive in, and the advancing notches 53 are formed in an oval-shaped to adapt to the ratchet 71 of the screw gun 7, and said ratchet 71 is formed in a tapering shape. Accompanying with the surrounding wall 525 disposed near the upper surface 511, wherein a recess 526 is defined by the encirclement of the surrounding wall 525, and the diameter D1 of said recess 526 is greater than the maximum outer diameter D2 of the hex washer head 81, which can be therefore contained into the recess 526, so that the outward appearance of the screw strip 5 is neat.

Furthermore, break points 524 extend to said surrounding wall 525, and the surrounding wall 525 of the recess 526 has a plurality of convex portions 527 extending to the open hole 522 in this preferred embodiment (as shown in FIG. 6) to prevent the screw 8 from dropping out of the screw strip 5 by the limit of the convex portions 527. When in operation, the screw 8 can be easily pushed out by the screw gun 7 by means of the break points 524 extending to the surrounding wall 525 of the recess 526.

Based on the aforementioned description, the present invention comes with the following functions:

(1) Because the advancing notches of the screw strip form in a closed state by the blocking of the side piece, the screw strip can be fixed firmly by the ratchet of the screw gun and be prevented from bending and deforming; therefore, the screw can be smoothly pushed out and will not be inclined to one side, which increases the accuracy of screwing.

(2) The width of the screw strip decreases due to advancing notches disposed between two open holes, thereby reducing the cost of materials.

(3) Break points extend to the surrounding wall of the recess; as a result, any screws can penetrate into the open hole and be easily pushed out after screwing, enhancing tool handiness.

To sum up, the present invention takes advantage of the advancing notches on the strip formed in a closed state by the blocking of the side piece, thereby reduces manufacturing cost; furthermore, the screw strip can be fixed firmly in position and be prevented from deforming.

While we have shown and described the embodiment in accordance with the present invention, it should be clear to those skilled in the art that further embodiments may be made without departing from the scope of the present invention.

I claim:

1. A screw strip comprises
a rectangular strip having an upper surface, a bottom surface opposite to said upper surface, and a flank connecting both said upper surface and said bottom surface;
a plurality of receiving sleeves, wherein each of said receiving sleeves includes a shield wall extending from said rectangular strip; an open hole is formed by the encirclement of said shield wall; a tapered portion opposite to the strip is formed at the end of said shield wall, and a plurality of break points are disposed on said shield wall; and
a plurality of advancing notches disposed on both sides of said rectangular strip, wherein a side piece is disposed on the side of each advancing notches.

2. The screw strip as claimed in claim 1, wherein said advancing notches are formed in a rectangle.

3. The screw strip as claimed in claim 1, wherein said advancing notches are disposed between two said open holes.

4. The screw strip as claimed in claim 1, wherein said open hole has a surrounding wall near said upper surface, in which a recess is defined by the encirclement of said surrounding wall; the diameter of said recess is greater than the maximum outer diameter of a screw head; said break points extend to said surrounding wall to accommodate a screw.

5. The screw strip as claimed in claim 4, wherein said surrounding wall of said recess has a plurality of convex portions extending to said open hole.
